(19) United States
(12) Patent Application Publication
(10) Pub. No.: US 2018/0253937 A1
(43) Pub. Date: Sep. 6, 2018

(54) PLAYING CARDS SECURITY SYSTEM

(71) Applicant: Cristian Vasile Curelea, Bucharest (RO)

(72) Inventor: Cristian Vasile Curelea, Bucharest (RO)

(21) Appl. No.: 15/701,485

(22) Filed: Sep. 12, 2017

Related U.S. Application Data
(60) Provisional application No. 62/467,285, filed on Mar. 6, 2017.

(51) Int. Cl. G07F 17/32

(52) U.S. Cl. CPC G07F 17/3241; G07F 17/322; G07F 17/3293

(57) ABSTRACT

An integrated hardware and software solution for minimizing player cheating at casino card games, increasing revenue and limiting damage to brand image is implemented. A cheating-free environment may be facilitated using embodiments of the system, which additionally provides advanced reporting, useful insights and derived analytics for each department. In exemplary embodiments, hardware components such as multi-spectra optical scanners and readers are integrated with a series of software modules to provide a comprehensive security solution. In embodiments, optical scanning devices may be incorporated into embodiments of the system to read indicators placed on the card decks, including visible and infrared indicators that provide detailed tracking and inventory information.

### PRIORITY CLAIM

This application claims priority to U.S. Patent Application No. 62/467,285, filed Jun. 3, 2017, the contents of which is incorporated by reference in its entirety.

### BACKGROUND

Player cheating at casino games is a consistent problem for casino operators, particularly in games utilizing playing cards. Unlike slot machines, roulette wheels, and dice games, playing card games involve simple equipment—one or more decks of playing cards—that leaves limited room for security countermeasures. The actual costs of player cheating are unknown since many operators prefer to keep such losses confidential, but various high-profile incidents shed some light onto the extent of the problem.

The sophistication of cheating methods has only increased over time, putting casinos on the defensive against ever-evolving high-tech methods. In card games, cheaters have employed techniques that include marking cards in advance so that the markings—while not visible to the naked eye—may be read with a particular lens. Cards may also be marked during the games by players seeking an unfair advantage.

In poker, mechanical markings on the rear of the card may be used to indicate the suit and or/value of the card. Markings that reflect only certain wavelengths of light—ultraviolet, for example—can also be used. While invisible to the dealer and pit boss, these markings can be viewed with specialized glasses worn by the cheating player. Since the players in a poker game can touch the cards, a cheating player may swap cards brought from outside the casino into the playing deck to secure an unfair advantage.

The game of blackjack can be manipulated similarly, though since players are unable to touch the cards, the range of cheating methods is more limited. In any game, corrupted employees working with the casino or a supplier may be enlisted to compromise the deck(s).

By manipulating the card decks, cheating players can secure an unearned advantage, often causing the casino significant losses in revenue. Cheating players have an impact on the experience of other players in the casino, causing those players greater losses, and diminishing their experience and view of the casino. A player who views a casino as “unlucky” or “unfair” may not return. Damage to the casino brand may also result.

Various types of anti-cheating and security measures have been proposed over the years, with limited efficacy. Many solutions have been countered by cheating players and rendered obsolete while others have interfered in the orderly flow of play, reducing the number of hands played and therefore, reducing casino revenues.

What is thus needed is an anti-cheating system that integrates seamlessly with the casino game flows, without adding overhead of time for the employees.

What is further needed is a system that provides a unified understanding of how card decks flow into a casino and maintains detailed statistics on that card flow.

What is further needed is a system that provides a comprehensive hardware and software approach to supervision, security, and recognition of the card decks.

What is further needed is a security system that results in increased revenue through not only diminished cheating, but also faster-played hands.

What is further needed is a security system that ensures a cleaner game for the normal players, thus protecting the brand.

What is further needed is a system that is adaptable to varied security mechanisms, including card pattern recognition, code recognition, and geolocation, and is adaptable to new mechanisms as they evolve.

What is further needed is a system that provides customizable security alerts that can be adjusted to the particular needs of the casino.

What is further needed is a system that provides customizable reporting, including a history of each card deck by usage (when it was added, for how long it was used, by who was used, when was discarded, etc.)

### BRIEF DESCRIPTION OF THE DRAWINGS

The features and advantages of the present disclosure will be more fully understood with reference to the following detailed description when taken in conjunction with the accompanying figures, wherein:

FIG. 1 is a schematic block diagram of a system built in accordance with the principles of the present invention.

FIGS. 2a-2c describe the card admittance processed used with embodiments of the present invention.

FIG. 3 describes an embodiment of the present invention integrated with a manually-dealt game of poker.

FIG. 4 describes an embodiment of the present invention integrated with a game of poker conducted using an automatic shuffler.

FIG. 5 describes an embodiment of the present invention integrated with a manually-dealt game of blackjack.

FIG. 6 describes an embodiment of the present invention integrated with a game of blackjack conducted using an automatic shuffler.

FIG. 7 describes an embodiment of the present invention integrated with a game of baccarat.

FIG. 8 describes the handover process to the dealer that utilized with embodiments of the invention.

FIG. 9 describes the handover process to the pit boss utilized is with embodiments of the invention.

FIGS. 10-14b describe scenarios for a theoretical improvement in revenue and performance by a casino implementing embodiments of the invention.

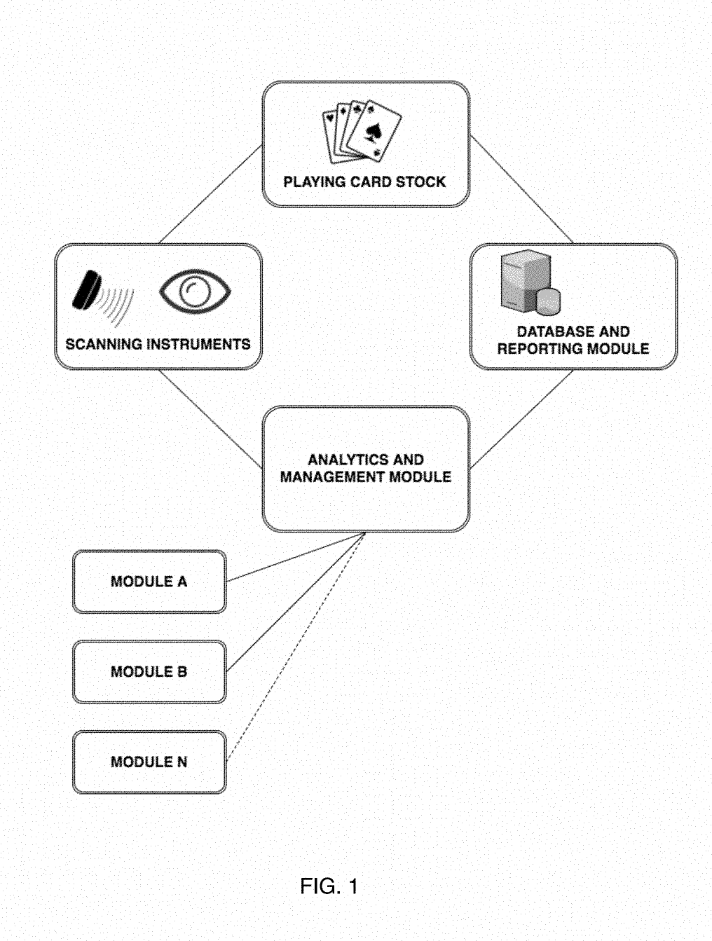

### DETAILED DESCRIPTION

An integrated hardware and software solution is described for minimizing player cheating at casino card games, increasing revenue and limiting damage to brand image. By handling all processes from inside a casino, the system of the present invention, referred to herein as PCSS, provides not only a cheating-free solution but also a better way to understand and improve the business via advanced reporting, useful insights and derived analytics for each department.

While the term “casino” is used throughout the present disclosure, it should be noted that the system and method of the present invention applies to varying game play environments, both professional and amateur. The term “casino” may include for-profit Las Vegas-style casinos, regional casinos, private gaming environments, public and private poker tournaments, fundraisers, “pop-up” casinos, casino theme parties, “fun money” casinos, and any other environment where the integrity of game play is of consequence.

In the case studies and examples herein, the focus is on the three most frequently played card games—poker, blackjack, and baccarat—though the invention is suitable for any card game in which the cards are shuffled by the dealer, whether manually or by a shuffle machine.

### Card Types

It will be appreciated by those of ordinary skill in the art that different types of playing cards may be utilized to suit an individual game, statutory requirements, casino requirements venue, or the like. The variations in card styles, sizes, and materials complicate efforts to maintain the security and integrity of the cards in a casino environment.

For example, for the game of poker, cards measuring 2.5″×3.5″ are standard. Other sizes may be available, including the narrow poker deck, which measures approximately 2.25″×3.4375″, or a bridge deck sized at 3.25″×3.5″. Poker cards are typically manufactured as paper cards laminated with a polymer coating and cards formed entirely of a polymer material.

Poker cards also come in a variety of designs, including the “standard index size,” the most common design, and the one preferred by many players. A super or jumbo index size is less common, with a larger print that makes it easier to see. Even larger is the magnum index size, an extremely large size print that takes up most of the face of the card. Lastly, a peek or dual index design has a standard size print on the face with additional fine print pips on the corners of each card.

For the game of blackjack, 2.5″×3.5″ is the industry standard for French cards the most used deck. Similar to poker cards, blackjack cards are most commonly manufactured from laminated paper or plastic.

Blackjack card designs can vary. Mamluk cards and their derivatives, the Latin suited and German suited cards, all have three male face cards. Queens began appearing in tarot decks in the early fifteenth century and some German decks replaced two kings with queens. While other decks abandoned the queen in non-tarot decks, the French decks retained the queen and dropped the knight as the middle face card. Face card design was heavily influenced by Spanish cards that used to circulate in France. One of the most obvious traits inherited from Spain are the standing kings. Kings from Italian, Portuguese, or Germanic cards are seated.

The myriad styles and sizes complicate the ability of casino operators to implement a comprehensive security system.

### Shuffling Types

Besides the cards themselves, a second variable in maintaining the security and integrity of the game may be the means of shuffling the cards. Card shuffling is used to randomize one or more decks of cards to introduce an element of chance into a game. It will be understood by those of ordinary skill in the art that while there are numerous methods and procedures for shuffling cards in a casino environment, three types are predominant.

The first common type of shuffling is manual shuffling, in which a dealer will unwrap a new card deck, verify it by spreading the cards face-up, turn the cards face-down and make a semi-shuffle. Following the semi-shuffle, the dealer will continue to run a shuffle mode for the cards accordingly to casino's internal procedures and policies. On some games, the dealer continues the shuffle and asks a guest to cut the cards. This procedure is often used to present the cards to the cameras to start the game. After the shuffling is finished, the game starts.

A second predominant type of shuffling is the game table shuffle machine. For the shuffling at the game table, the dealer unwraps a new card deck, verifies it by spreading the cards face-up, turns the cards face-down and makes a semi-shuffle. After the semi-shuffle is complete, the dealer will insert one or more card decks (depending on the game) into the shuffling machine to commence the automated shuffle. After the automated shuffle is finished, the game commences.

Lastly, in some casinos, a shuffle room may be provided. The shuffle room, which may be sealed and controlled by security, has one or more shuffle machines that can shuffle single or multiple decks. Usually this machine is used to automatically shuffle the cards that are then stored in a secure container, preferably transparent, that will be sealed and handed over to the pit boss responsible for each shift. Baccarat is often played with shoes prepared in this manner.

### Personnel

In addition to the playing cards and physical equipment, embodiments of the invention rely on the coordination among a plurality of entities within the casino. While each casino has a different department structure, depending on its type, location, and size, some key departments/employees that are present no matter the organizational structure.

Embodiments of the invention may involve an administrative department. The administrative department may be represented by the casino manager directly or another employee in charge of card deck order and acceptance. Where a casino utilizes the optical reading features described below, the administrative department will handle the reading and coding of card decks.

Embodiments of the invention may utilize—or be utilized by—a logistics department of casino management. This department may handle card deck validation, inventory, and storage. This department may also verify the card deck codes (if applicable) to double-check the previous department.

In embodiments, a surveillance department may be a part of the system. The surveillance department typically handles the monitoring of staff and gameplay, and also coordinates the destroying or re-enter in the game of card decks.

Lastly, a pit boss may be involved and charged with the responsibility of watching the dealers for errors and to ensure that proper procedures are followed, payouts are handled correctly, and guests are treated properly. The pit boss may be called whenever there is any problem or requirements made by the players.

### Security Features

As discussed below, embodiments of the system provide a specifically-defined flow to keep track of card decks from the arrival from the manufacturer to the return from the table. Each checkpoint is pre-defined and available to definition (e.g., roles, users, availability) by the system administrator. One or more security features may be incorporated into the flow of a casino's card decks and related operations, in accordance with embodiments of the invention.

To provided an additional layer of security, user account roles may be provided such that each user has a predefined access role that can be defined module wide or functionality wide. To protect password exchange between users, each user may be required to input an SMS generated access code along with his code (or a key card, access card, token, etc.). To protect confidential data, a login session may last for a predetermined interval (e.g., 30 seconds) before the user is required to re-enter their login credentials.

In embodiments, a data protection element may be incorporated into the implementation. All collected data that is stored into PCSS' database will be encrypted using a private key embedded into the application. No human will be able to read data from the database to protect both collected data but also data corruption/modification.

In embodiments, each checkpoint defined into the card decks flow may require at least two parties: (1) the user that makes the action and (2) the user that continues the action. The four-eye check system will always allow a double checking of the receiving data by the user that continues the action. This way there will be no checkpoints left unverified.

Card deck identification is an important part of the embodiments of the present invention. Each deck, when arrives at a game table will be scanned and identified as to being the one that was sent by the pit boss to that specific table. A related concept is card identification or reporting. When a deck (or more) is inserted into the shuffle machine, the cards may be scanned (on all edges) for both code and mechanical markings. The scan may be made using a lens capable of detecting light in multiple frequency spectra—e.g., visible and infrared—to read an infrared code and mechanical visible marking.

In embodiments, security alerts may be implemented to alert in real-time the issues related to card decks and even individual playing cards. Alerts may arise from the mismatching of codes/design and result in critical alerts for the security department. For all failure statuses arising in the system, the system may raise alerts (based on the checkpoint) to the security department.

The alerts are defined as follows: (1) medium importance (e.g., the time between receipt to delivery is exceeded); (2) high importance (e.g., card decks are not returned); and (3) critical (e.g., missed scan, mismatch of cards, etc.).

### Code

In embodiments, unique security codes may be utilized to verify card decks. Whether the casino will use the RFID options, optical options or only the management option, PCSS may generate, read and report data based on card security codes.

An example of a security code is a manufacturer package code, which is a unique code placed on the package received from the manufacturer. Where not pre-generated by the manufacturer, it may be generated on-site.

In embodiments, a security code may be a barcode containing an alphanumeric string encrypted by a public key cryptography. An exemplary manufacturer package code may include elements such as: casino ID (generated by PCSS and sent to the manufacturer); package ID (generated by the manufacturer;); card deck identifier; and a control key. The control key may be implemented as a CRC32 or cyclic redundancy check, an error-detecting code commonly used in digital networks and storage devices to detect accidental changes to raw data.

In embodiments, a manufacturer card deck code may be utilized. This code is unique based on the deck received from the manufacturer, and if not pre-generated, it can be generated on-site.

An exemplary manufacturer card deck code may be a barcode containing a public key encrypted string and include elements such as: casino ID (generated by PCSS and sent to the manufacturer); package ID (generated by the manufacturer); and a control key.

In embodiments, a manufacturer card code may be utilized. This code is unique based on the deck received from the manufacturer and similar to the other security codes, if not pre-generated by the manufacturer, it can be generated on-site. The format may be a barcode containing a public key encrypted string. Elements of an exemplary manufacturer card code may include: casino ID (generated by PCSS and sent to the manufacturer); card deck identifier; and the control key.

In embodiments using RFID scanning, each deck, when it arrives at a game table will be scanned and identified as to being the one that was sent by the pit boss to that specific table. Additionally, when a card deck is scanned at the table and the action is successful, the RFID reader embedded into the table is commanded by PCSS to retrieve all available chips regarding of this deck. RFID uses electromagnetic fields to automatically identify and track tags attached to objects and includes subsidiary technologies such as NFC or near-field communication.

Security alerts for implementations using RFID scanning may advise of real-time of issues related to card decks and individual cards, including: (1) card deck alerts; (2) card code alerts; and (3) area alerts (a card leaves the game table/playing area).

In embodiments using optical scanners, card decks may be scanned and identified as to being the one that was sent by the pit boss to that specific table.

Card matching for optical scanning embodiments may include scanning the cards when one or more decks are inserted into the shuffle machine, to read and verify (on all edges) both the code and mechanical markings. The scan may be made using a multi-spectra lens that can read infrared markings on the thin edges, and identify the card code, and visible light to identify the card model and template. Using this technology, PCSS can alert in real-time the issues related to card decks and individual cards (individually). All alerts derived from the mismatching of codes/design result in critical alerts for the security department.

### Integrated Software & Hardware Solution

As discussed herein, in a preferred embodiment of the system, hardware components such as scanners and readers are integrated with a series of software modules to provide a comprehensive security solution. In embodiments, optical scanning devices may be incorporated into embodiments of the system to read indicators placed on the card decks.

For example, secure number codes may be placed on the cards decks, either on the deck packaging, or individual cards, using a high-security printing sheet numbering system. These number codes may be securely issued and recorded to ensure the integrity of the card decks.

Existing sheet numbering systems have been utilized for applications other than card deck tracking and may be adapted for this purpose. Codes make be alphanumeric or bar codes. Exemplary systems for use with the invention include the high-security numbering machines by Paul Leibinger GmbH & Co. KG of Tuttlingen, Germany; the inkjet sheet numbering device by Manroland Sheetfed of Offenbach am Main, Germany; and the Laser Marking System by Keyence Corporation of Itasca, Ill. These devices each facilitate the secure printing of code on each product—whether card or card deck—and monitoring of the finished printout.

Embodiments of the system may further utilize an optical reader to read the code printed on the cards or card decks. Universe Kogaku of Oyster Bay, N.Y. manufactures a line of lenses suited to code scanning and character recognition that have been found to work with embodiments of the invention. Photon Gear of Ontario, N.Y. also manufactures specialized imaging lenses that may be used with embodiments of the invention.

In embodiments, RFID (radio frequency identification) and NFC (near-field communication) tags may be embedded directly in individual playing cards, or decks of cards. These tags may then be interrogated by a specialized reader to determine the security code associated with the card or card deck.

In embodiments, an analytics and management module (“AMM”) may be provided to ensure security and integrity, provide inventory management, and calculate and report analytics, among other features. For example, a security code read from a playing card—either by an optical scanner, RFID/NFC reader, or manually—can be cross-checked against a database of verified card security codes to verify the integrity of the card. The speed of play, number of hands per hour, number of players per hour, and other metrics may all be calculated in the AMM once the individual cards or card decks have been identified.

In embodiments, AMM may be utilized without the embedded tracking features described above such as embedded surety codes and automated readers.

In a preferred embodiment, an SOA (service-oriented architecture) layer may be provided to enable module connectivity and allow external applications to gain access to its resources. A service-oriented architecture is a style of software design where services are provided to the other components by application components, through a communication protocol over a network. The specific implementation of such an SOA will be understood by a person of ordinary skill in the art.

The various modules of the AMM will now be described.

In embodiments, a Users Module may be provided to handle both the user login and management. The main functionalities of a Users Module may include: login, registration, password management and recovery, user administration, reporting, and user action logging, among others.

In embodiments, a Logistics Module may be provided to handle the storage and administrative elements for a casino. The main functionalities of a Logistics Module may include: order management, order confirmation, storage management, inventory, disposal management, order reporting, storage reporting, inventory reporting, and disposal reporting, among others.

In embodiments, a card Decks Flow Module may be provided to handle the flow of individual card decks through a casino. The main functionalities of the Card Decks Flow Module may include security code generation (for individual cards, decks, and packages), code identification (for individual cards, decks, and packages), “four-eye” check confirmation and approval, card scan registration, card identification, and flow reporting, among others.

In embodiments, an Alerts Module may be provided to handle alerts for security or management. The main functionalities of this module may include: alert management, SMS alert integration, alert display, and alerts reporting, among others.

In embodiments, an Administration Module may be provided to handle the configuration of the software by a system administrator. Functionalities of this module may include: role management (users), range settings (e.g., from pit boss to table to from first to next scan), department management, card flow direction (on scan), and other user-defined settings.

In embodiments, a Reporting Module may be provided to handle the BI reports available for the system administrator or casino manager. The main functionalities of this module may include: user activity trends, card flow trends, cheating prevention, fault analysis (errors on scans), card decks analysis, and departmental analysis, among others.

An SOA layer may interconnect the modules to one another and to a centralized database. Using this architecture, each module is both independent and interconnected (via a service broker) with the whole PCSS environment. The interconnection may be facilitated by a service broker, which makes the information regarding the web service available to any potential requester.

In embodiments, a PCCS database layer may be provided comprising two elements. A Data Warehouse is provided that only permits insert/read to maintain complete data integrity. Data Marts are small databases available for each module with only the latest information available.

In addition to the foregoing, AMM may incorporate additional modules or module features depending on the specific hardware configuration.

Using the optical reader, PC SS may automatically enable a Logistics Module, Card Decks Flow Module, and Reporting Module with features that leverage the additional capabilities of the hardware.

An enhanced Logistics Module in a system incorporating an optical read may enable manufacturer package identification via private key, card decks identification via Manufacturer Package, and Codes storage. Similarly, an enhanced Card Decks Flow Module may enable: Integration with shuffle machine software on Card Matching, Card pattern recognition, and Card code identification. An enhanced Reporting Module may enable: Codes storage reports, Pattern recognitions, Pattern errors, Code recognitions, and Code errors.

In the case of RFID/NFC-enabled systems, these modules may be enhanced with additional functionality to take advantage of the RFID/NFC features. An enhanced RFID/NFC Logistics Module may further provide: Manufacturer Package identification via private key, card decks identification via Manufacturer Package, Codes storage, Codes generation, and Codes writing on RFID. The Card Decks Flow Module in an RFID/NFC system may provide: Integration with RFID reader to identify the cards RFID chips, Card codes recognition, and card area recognition. The enhanced Reporting Module may further provide: Codes storage reports, Code generation reports, RFID readings, RFID errors, RFID area readings, and RFID area reports.

### Card Flow

In embodiments of the invention, the flow of playing cards into the casino facility may be monitored and tracked using specialized equipment and features embedded in the playing cards.

### Card Decks Admittance

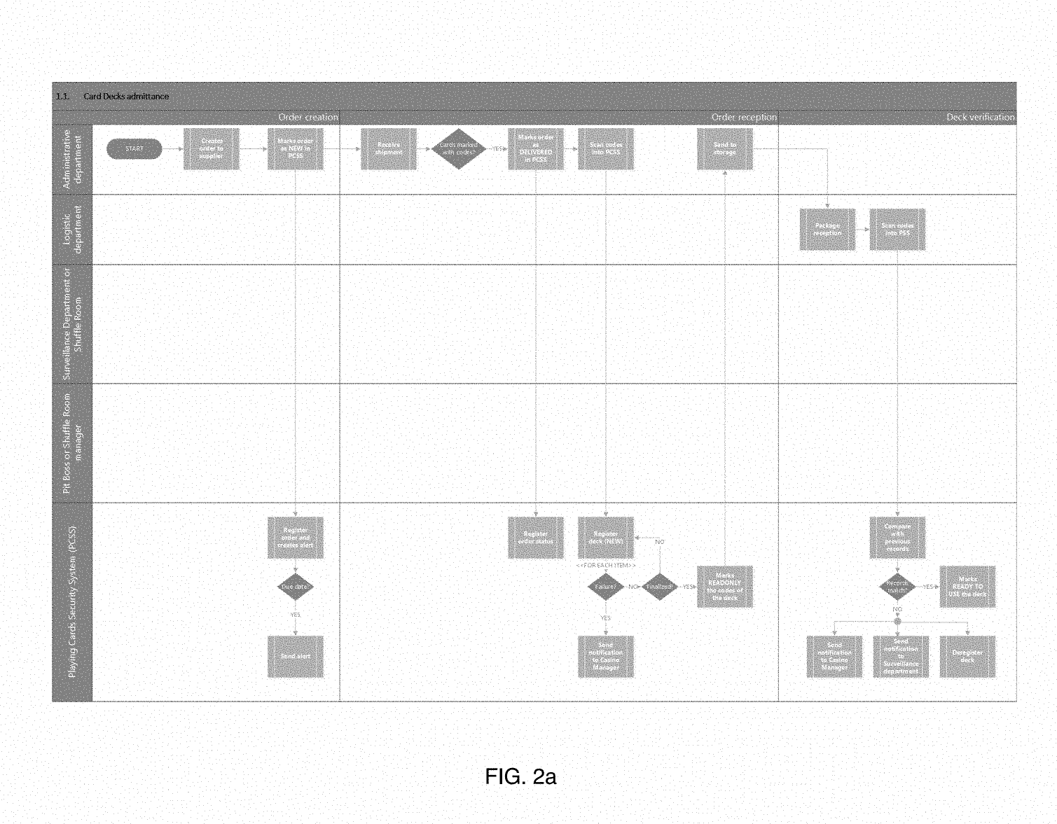

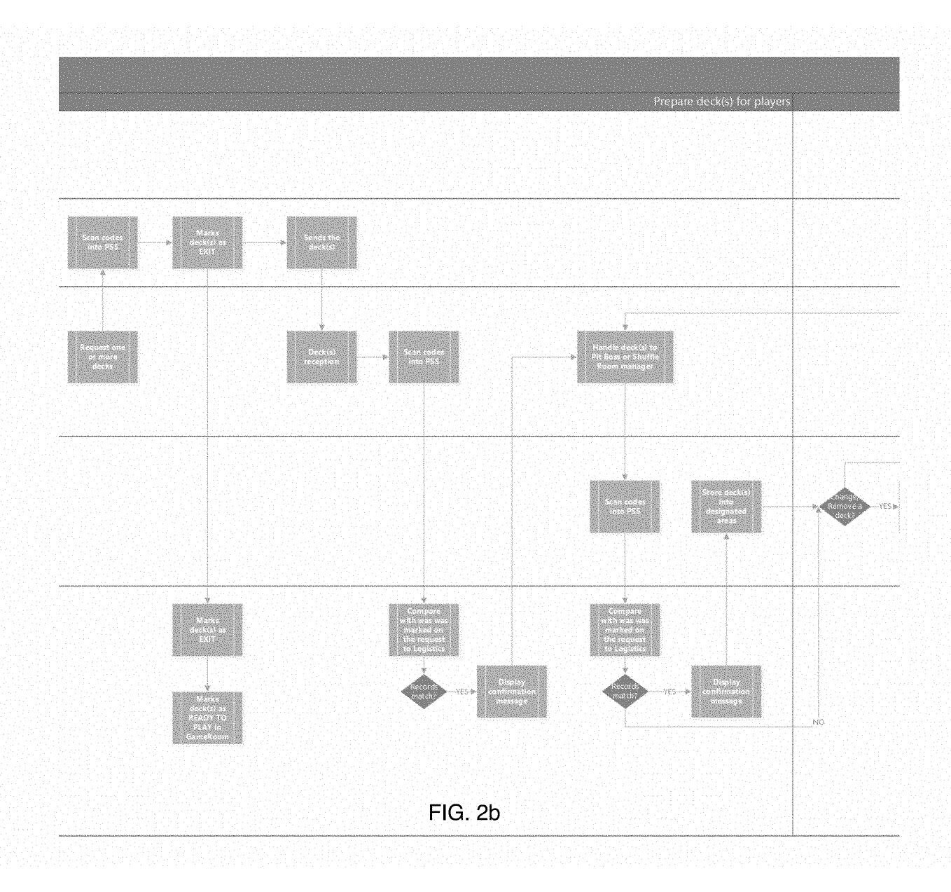

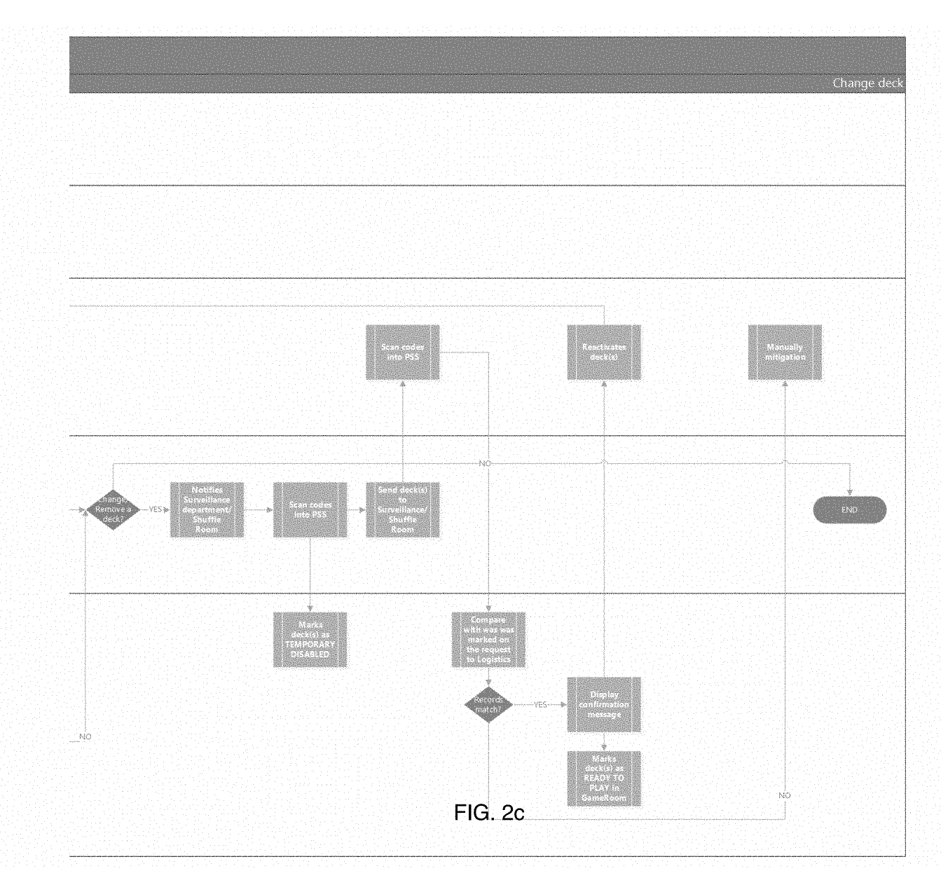

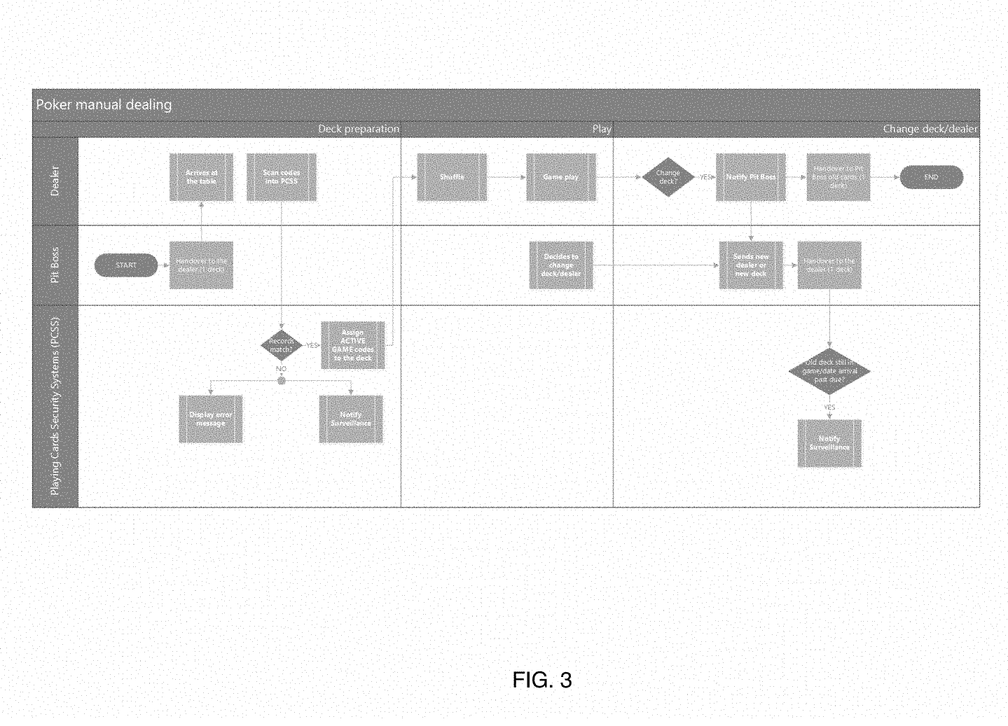

In embodiments of the invention, the method for introducing new decks of cards into the casino environment is regulated. The method remains largely the same depending on whether the casino is small or large. The steps in the card admittance process can be divided into order creation, order reception, verification of the card deck, preparation of the deck for players, and changing the deck. These processes are generally described by the flowcharts shown in FIGS. 2a-3c.

Referring to FIG. 2a, an administrative department may create and place an order for card decks, via e-mail, phone, or any other communication means. The administrative department may enter the order into the Supply Module of PCSS, with quantity and any other relevant details. A shipping date may also be entered at this step to create an alert for shipping so that when the due date is reached, PCSS will send an alert via e-mail, message, or other communication means.

Referring still to FIG. 2a, the steps are shown for reception of a new deck of playing cards. After the cards are received, a determination may be made whether the cards have been marked with codes or indicators that can be detected by the PCCS system.

If the manufacturer codes the cards with codes (for both optical or RFID solution), the administrative department handles the new received packages as delivered into PCSS and scans the codes (step 320). PCSS will store the codes that are coded on the cards or into the RFID Chips. In case of failure (step 324), an administrator—such as the casino manager—is notified. Once the scan is final, no user can modify the data thus ensuring the process is safe.

The card deck may then be sent to storage for later use. FIG. 2a shows the steps of an embodiment of the system after the deck has been retrieved from storage. When retrieved by a logistics department before use (step 330), the package may be scanned into PCCS, which will compare the codes (step 334) to prior records to verify the deck. If the deck is authenticated and verified, it is marked as ready to use the Logistics Module of PCSS (step 336). If a failure or error condition occurs, both the casino manager and surveillance department may be notified (steps 338, 340), and the new codes will not be registered into the system (step 342).

As shown in FIG. 2b, the deck is next prepared for use by players. For the games (on shift start, casino open or even during the working time) a new deck(s) is requested only by the pit boss only to surveillance department or shuffle room.

The logistics department scans one or more decks (depending on the number requested) into the logistics module of PCSS to register the exit of the decks. PCSS will also register into the game room the new decks as available for play.

The surveillance department or shuffle room may also scan the new card decks into PCSS as received to double check that was sent from the logistics department is per their request. The surveillance department or shuffle room will then hand over the card decks to the pit boss, who will scan the received card decks into PCSS to ensure the flow or request is correct, and store it in their designated areas. Only then the cards will be ready to use in the casino game room.

When one or more card decks need to be changed or removed, the pit boss requests this action to the surveillance department. The pit boss will scan the deck and send it back to the surveillance department or shuffle room. From that moment on, the codes from the cards will enter a temporary disable status. Only the surveillance department can re-enter that card deck into play, by scanning it into PCSS and reactivating the codes—the reactivation will take place only if the card deck is a perfect match on the scanner with the card deck that was initially requested by the logistics department.

Embodiments of the system may vary depending on the type of game. For example, FIG. 3 describes an embodiment of the system integrated into a manually-dealt game of poker.

The pit boss hands over the deck to the dealer, as described herein. The dealer may then arrive at the game table and scans the card deck into PCSS just before the beginning of the shuffle. Only at this point will the card deck will have active game codes, to be played at the assigned table. If the process fails, the surveillance department is notified.

The dealer may then start the manual shuffle, commencing the game.

Next, the dealer may receive a card deck change from the pit boss. The pit boss will send a new card deck to the table or sends a new dealer with a new card deck. If a new dealer is sent to the table, with a different card deck, PCSS will verify the pre-set arrival interval and notify the Surveillance department if the date is past due and the old card deck is still in play at the table.

The handover process to the new dealer or the new deck takes place according to the parameters described herein. A handover from the replaced dealer to the pit boss or of the replaced deck to the pit boss may also take place.

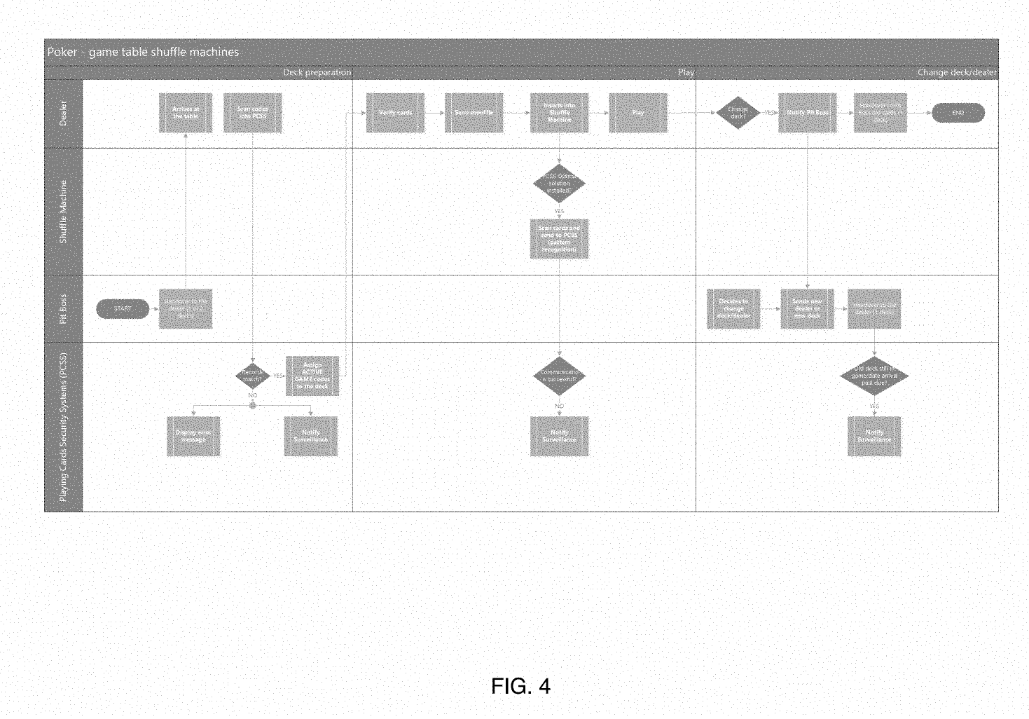

FIG. 4 describes the integration of the system into a poker game using an automatic shuffling machine.

The pit boss may request a dealer to hand over a one or two card decks (of different colors) and hands over the deck(s) to the dealer. The dealer then arrives at the game table and scans the card decks into PCSS just before the beginning of the shuffle. Only at this point, the card decks will have active game codes, to be played at the table. If the process fails, the surveillance department is notified.

The dealer may start to verify the cards (face-up) and starts the semi-shuffle. The dealer then inserts the card decks (one by one) into the shuffle machine.

If the optical solution of PCSS is present, the shuffle machine will scan and communicate with PCSS to verify the cards using card pattern recognition. If the process fails, the surveillance department is notified. If verified, the game commences.

During the game, the dealer may receive a card deck change from pit boss. The pit boss will send one or two card decks to the table or sends a new dealer with one or two card decks. If a new dealer is sent to the table, with different card decks, PCSS will verify the pre-set arrival interval and notify the surveillance department if the date is past due and the old card decks are still in play at the table.

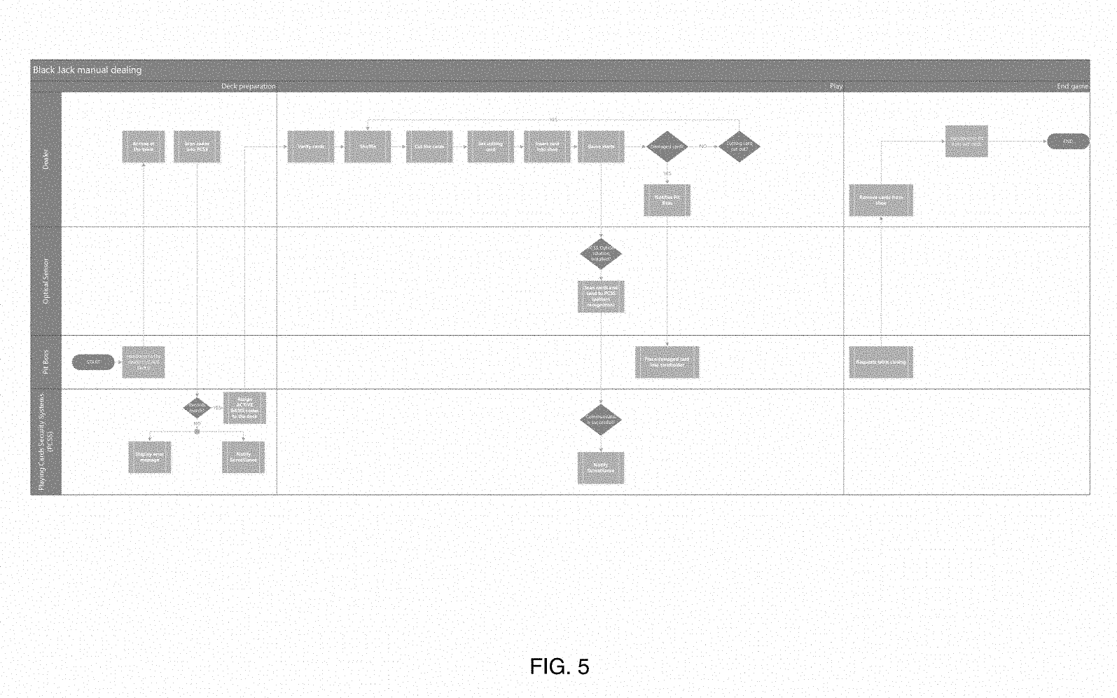

FIG. 5 describes an integration of the system into a game of blackjack using manual dealing. The pit boss first requests a dealer to hand over one, four or six decks, and hands over the deck(s) to the dealer. After arriving at the game table, the dealer may scan the card decks into PCSS just before the beginning of the shuffle. Only at this point the card decks will have active game codes, to be played at the table. If the process fails, the surveillance department is notified.

Following the shuffle, card-cutting, and placement of the cards in the show, the game commences.

If the optical solution of PCSS is present, the optical sensor will scan and communicate with PCSS to verify the cards using a card pattern recognition process. If the process fails, the surveillance department is notified. If a card is damaged the dealer will inform the pit boss, and the damaged card is replaced.

When the cutting card comes out, the dealer restarts the shuffle.

When the pit boss enacts the process of table closing, the dealer removes all cards from the shoe.

The handover process from the dealer to the pit boss then takes place, as described herein.

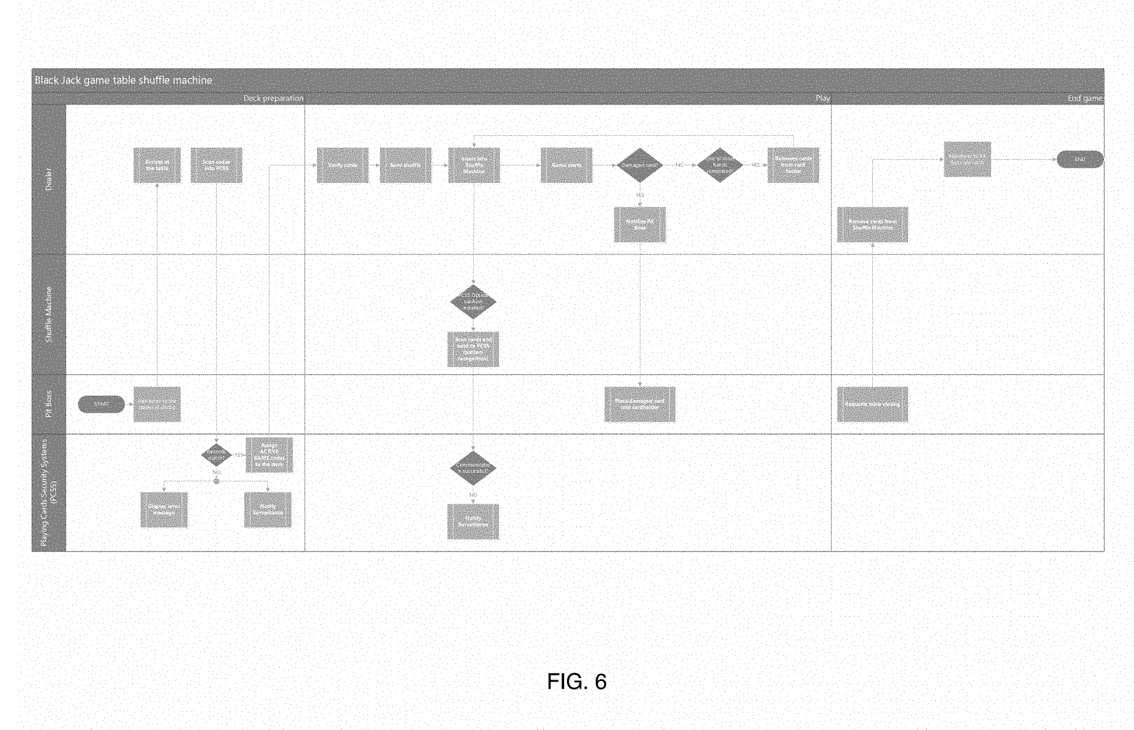

FIG. 6 describes the prior game using an automated shuffling device.

The pit boss may request a dealer to hand over one or six card decks and hands over the decks to the dealer. The dealer arrives at the game table and scans the card decks into PCSS just before the beginning of the shuffle. Only at this point, the card decks will have active game codes, to be played at the table. If the process fails, the surveillance department is notified.

The dealer may then begin to verify the cards (face-up) and start the semi-shuffle, after which the cards are inserted into the shuffle machine. The dealer may insert all the cards into the shuffle machine.

If the optical solution of PCSS is present, the shuffle machine may scan and communicate with PCSS to verify the cards (cards pattern recognition). If the process fails, the surveillance department is notified. The game then commences if verification is successful.

If a card is damaged the dealer may inform the pit boss, and the damaged card will be replaced. After a hand (or more) are complete, the dealer may take the cards from the card holder and reinsert it into the shuffle machine. Lastly, when the process of table closing is enacted, the dealer removes all cards from the shuffle machine.

The handover process from the dealer to the pit boss will then take place.

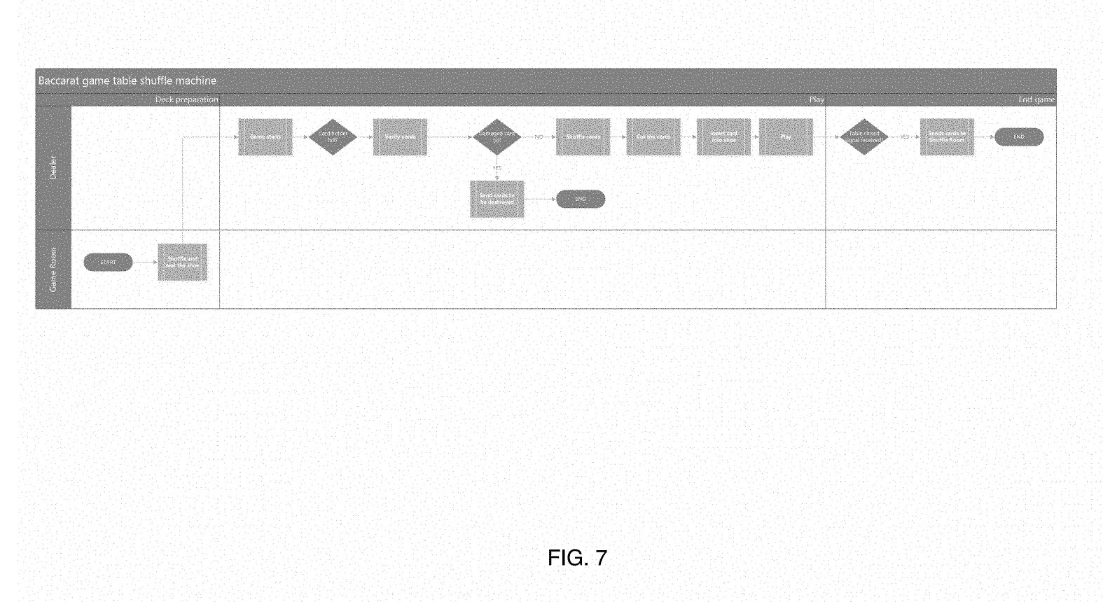

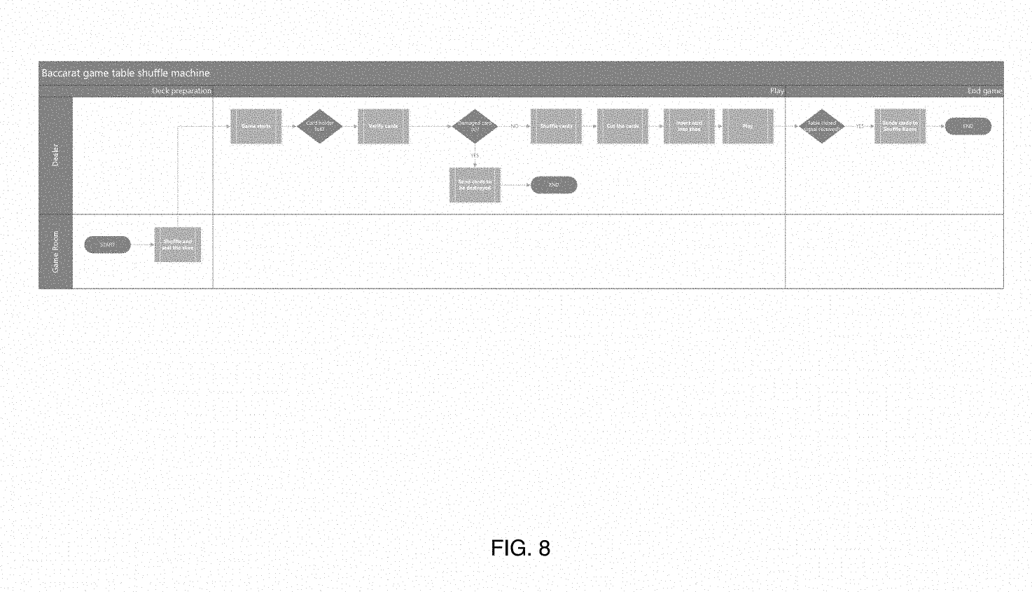

Referring to FIG. 7-8, an embodiment of the present invention is shown, integrated with the game of baccarat.

The shuffled cards arrive in a sealed shoe from the shuffle room, and the game commences. If the card holder is full, the dealer verifies the cards, and if any are damaged, they are replaced and sent to be destroyed. If the cards are not damaged, the dealer then shuffles the cards, asks a client to cut the cards, and reinserts the cards into the shoe. When the table is closed, the dealer (after sorting the cards) will send the shoe back to the pit boss to be verified.

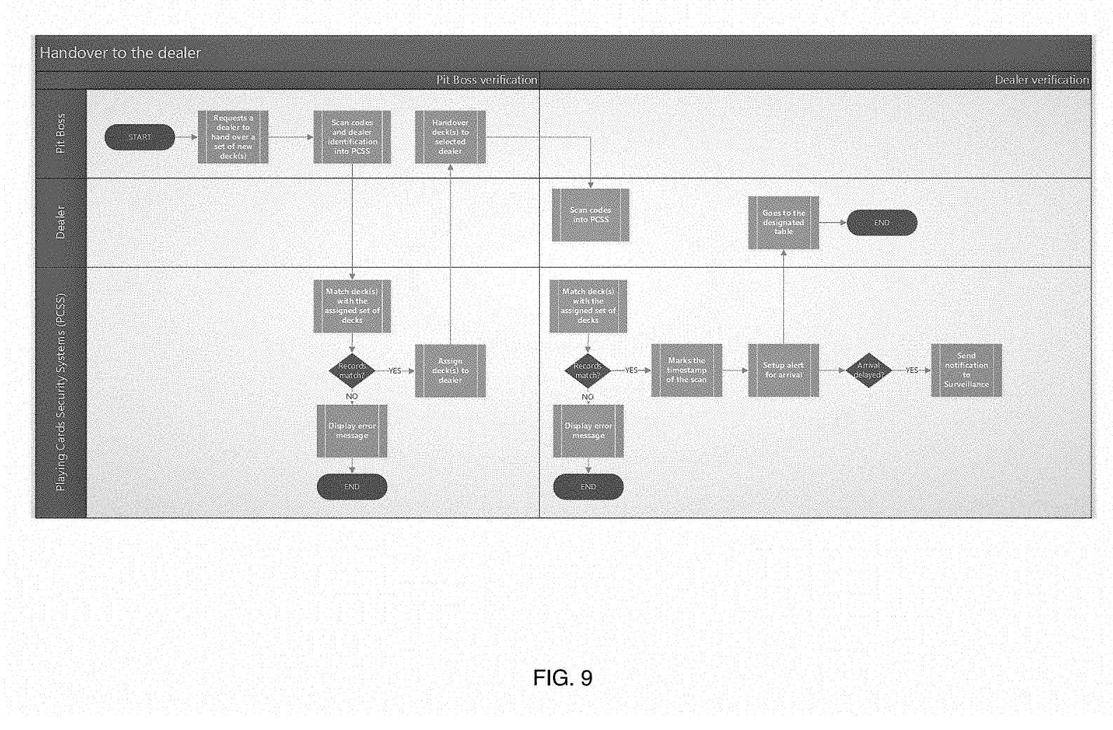

FIG. 9 describes the handover process to the dealer that is utilized in the above examples, and with embodiments of the invention. Here, the pit boss requests a dealer in order to hand over one or several card decks. For each card deck, the pit boss scans the card deck into PCSS. PCSS will match the card deck to the one for which the pit boss already made a scan of receiving from surveillance (see FIGS. 2a-2f). The process will be completed successfully only if the card deck matches perfectly with the one described above.

If the match is successful, PCSS stores the handover of the deck to the dealer, and the dealer receives the new card deck and proceeds to his designated game table.

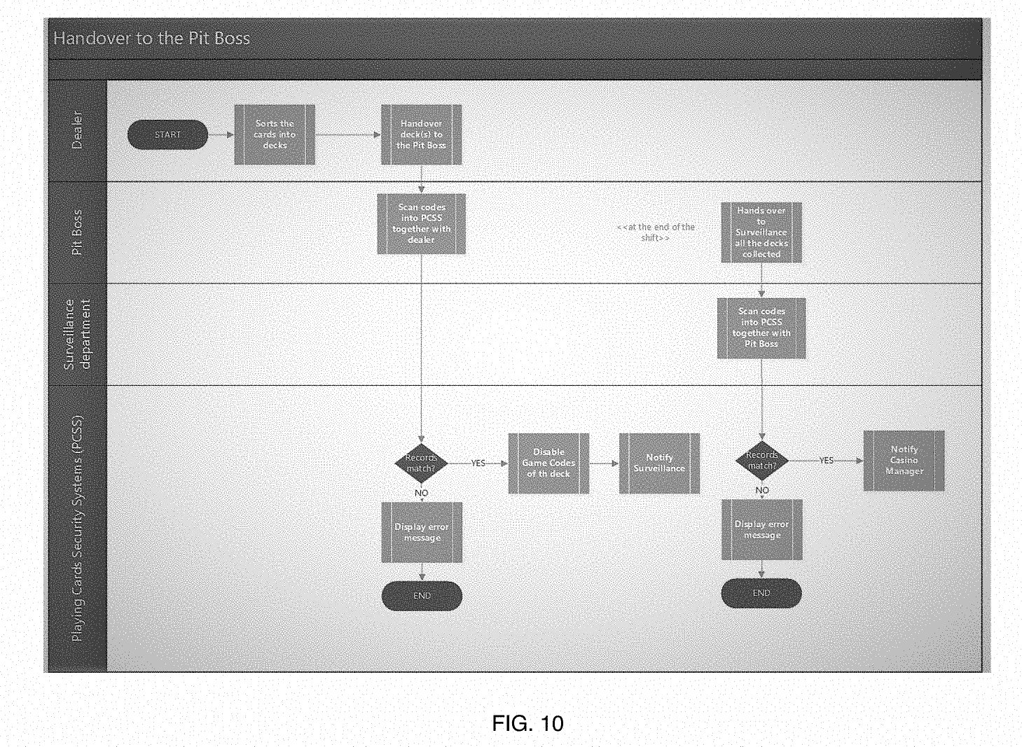

In a handover to the pit boss, as described in FIG. 10, the dealer sorts the cards into card decks, and a table inspector will verify that the decks are complete. The dealer hands over the card decks to the pit boss. Both the dealer and pit boss will scan the card decks (ensuring the codes are disabled) into PCSS. PCSS will notify the Surveillance department of the new card decks that are about to arrive.

The pit boss will then gather the card decks that were collected during the shift and hand them over to the surveillance department.

Both the pit boss and surveillance department scan the card decks to complete the process. PCSS will notify the casino manager of this action after it is made.

### Case Study

It has been found that by implementing embodiments of the present invention, significant financial benefits can be obtained.

For example, a typical poker dealer with seven players playing for one hour will deal from 38 to 44 hands. This time will be optimized for about 75% by simply using PCSS with a card scanner at the table. By scanning the deck, the dealer will not be forced to continue to turn the cards and inspect it, just scan it and continue the shuffle. This action will also prevent any cheating methods and empower the normal player to enjoy the game(s) and continue playing without any doubts.

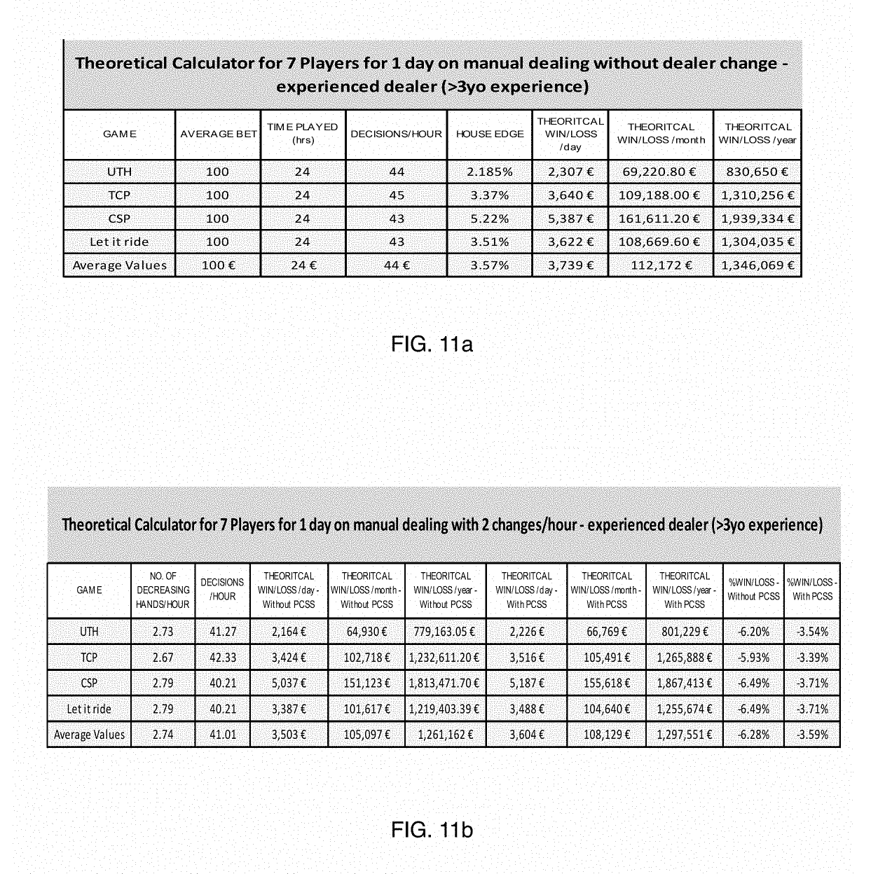

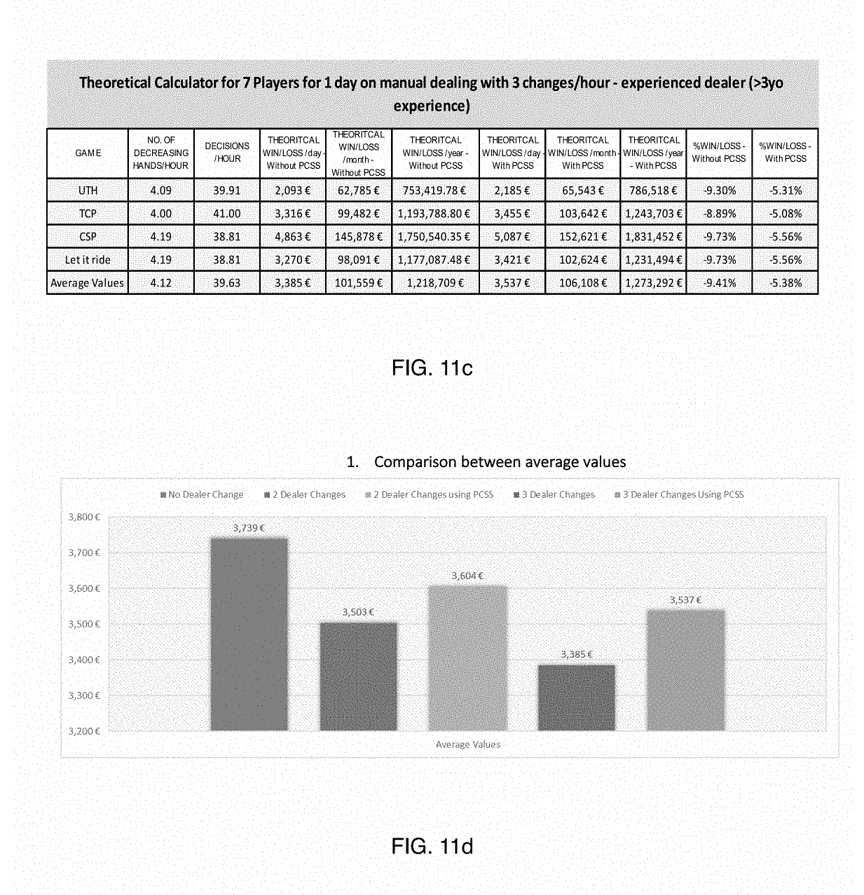

FIGS. 11-13 describe scenarios for a theoretical improvement in revenue by a casino implementing embodiments of the invention. Statistics are shown for the games of Ultimate Texas Hold 'em, Three-Card Poker, Caribbean Stud Poker, and Let It Ride, under varying dealer changes.

FIG. 11a shows a theoretical win/loss for these four games for seven players over a single day without any dealer change, and assuming a dealer having at least three years of experience. FIG. 11b shows the statistics for the same four games, with the same seven players over a single day, and the same dealer, but with two dealer changes. FIG. 11c shows the same scenario but with three changes per hour. As summarized in the table of FIG. 11d, significant revenue performance is realized where the PCCS system of the present invention is implemented.

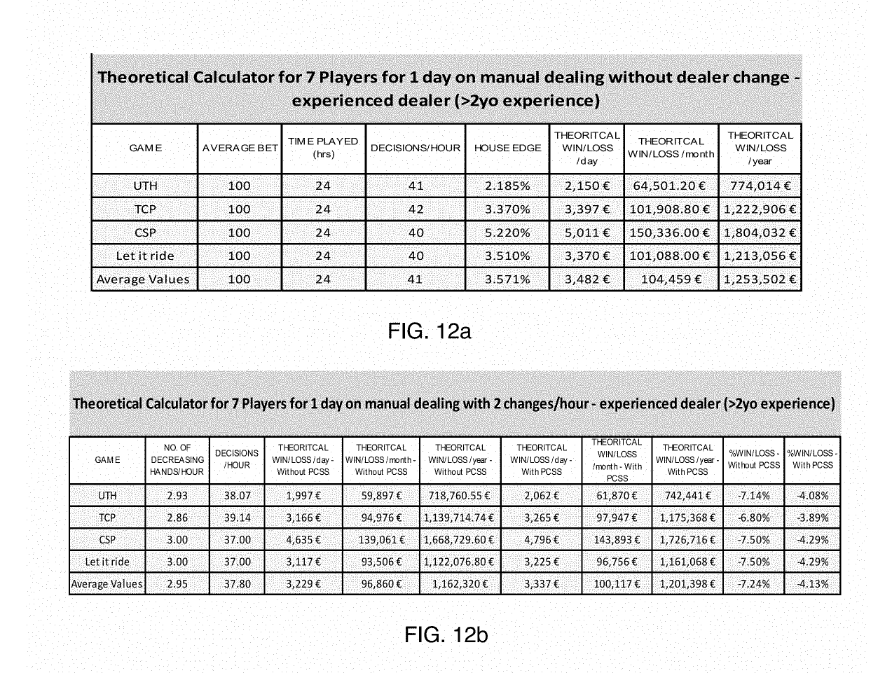

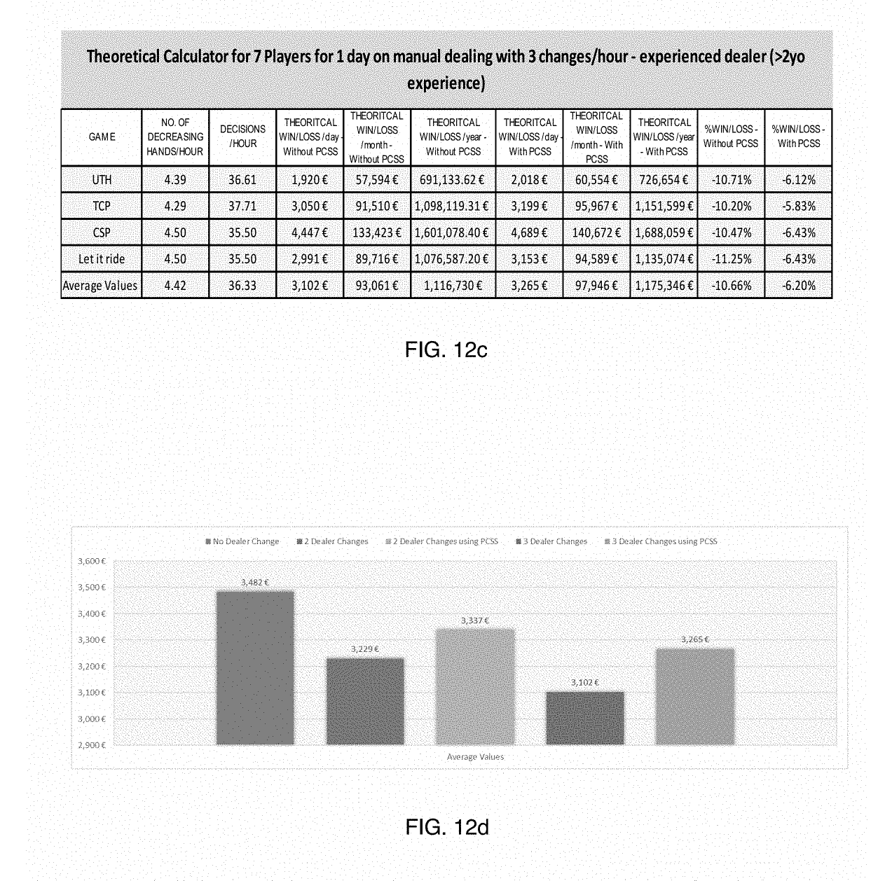

FIGS. 12a-12c show a theoretical calculation for seven players on manual dealing with a dealer having less than two years of experience. FIG. 12a shows the performance without a dealer change, FIG. 12b with two changes per hour, and FIG. 12c with three changes per hour. FIG. 12d summarizes the comparison between average values.

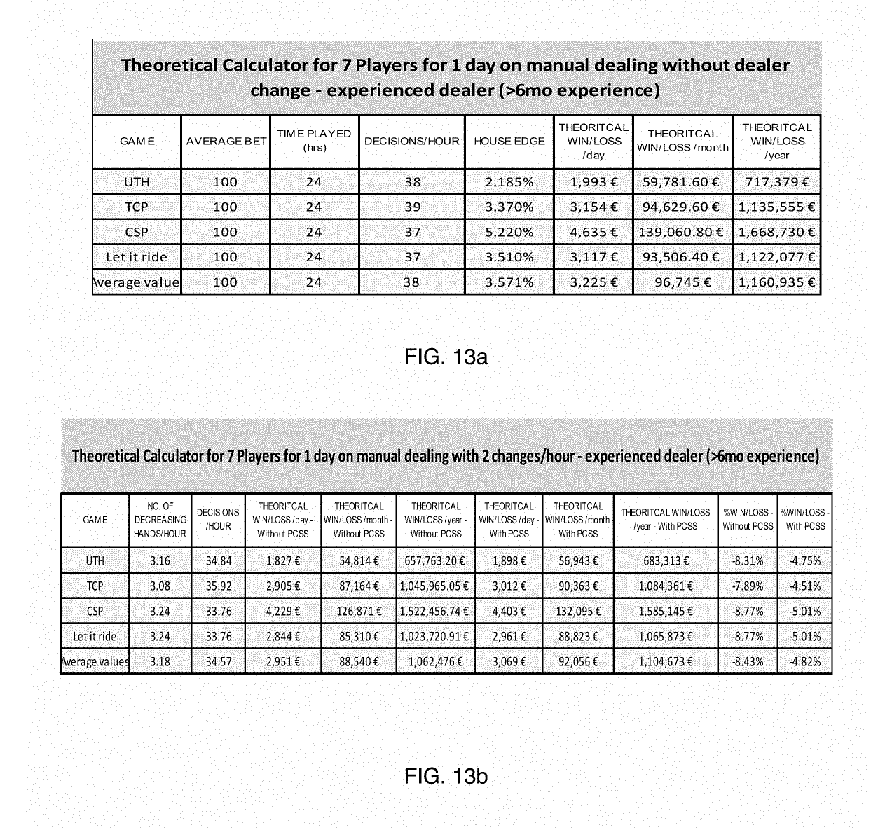

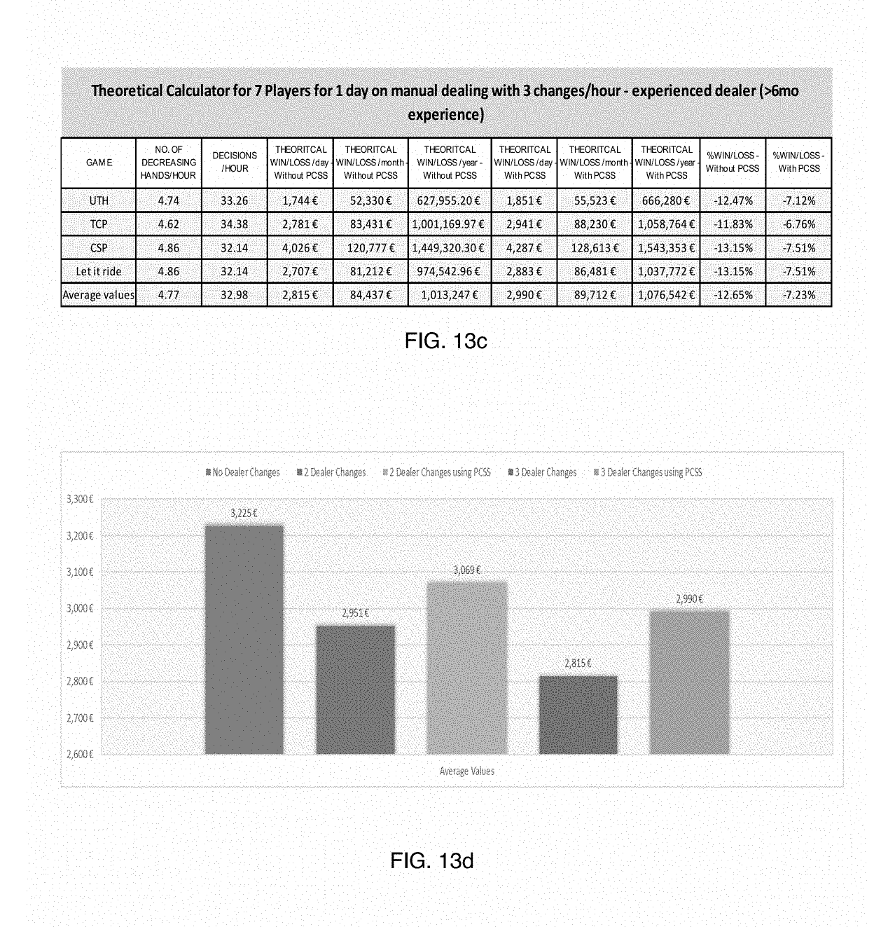

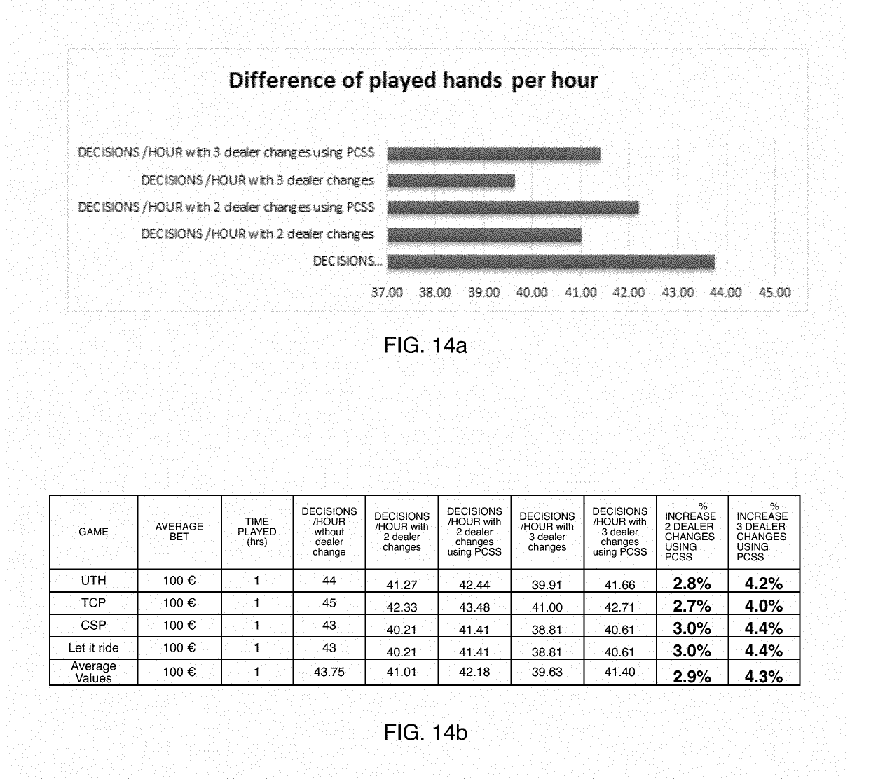

FIGS. 13a-13c show a theoretical calculation for seven players on manual dealing with a dealer having only six months or less of experience. FIG. 13a shows the performance without a dealer change, FIG. 13b with two changes per hour, and FIG. 13c with three changes per hour. FIG. 13d summarizes the comparison between average values. FIGS. 14a-14b further describe increases in performance where embodiments of the present invention have been implemented.

### Constraints

It will be recognized beby a person of ordinary skill in the art that for the system of the present invention to be implemented, certain constraints and system requirements may be imposed.

With respect to networking, a separate network is preferred having very limited access, to set up the software environment. The separate network would be inaccessible to casino clients and kept private.

For system hardware, the hardware environment—including servers, devices, and the like—should be installed on-site, with no internet access, and LAN access only in the private network previously created.

For software, PCSS may provide a middleware layer for communication with external software through an API. The API can provide the casino departments predefined access to view, read and write only with casino manager and surveillance manager's approval. Internal IT configurations may be required to enable the API.

It will be understood that there are numerous modifications of the illustrated embodiments described above which will be readily apparent to one skilled in the art, including any combinations of features disclosed herein that are individually disclosed or claimed herein, explicitly including additional combinations of such features. These modifications and combinations fall within the art to which this invention relates and are intended to be within the scope of the claims, which follow. It is noted, as is conventional, the use of a singular element in a claim is intended to cover one or more of such an element.

We claim:

1. A system and method for tracking and verifying playing cards in a playing environment, comprising the steps of:
receiving an unused card deck;
scanning the card deck to determine whether a security token has been applied to the card deck and, where no security token is identified, generating and assigning a security token to the card deck;
recording the security token in a database module;
causing the card deck to be transferred to a game environment in response to a transfer request for a new card deck, and recording the transfer in the reporting database module;
receiving the card deck at the game environment and reading, using a token scanning device, the security token applied to the card deck;
performing a database lookup of the security token present on the card deck to verify at least one card deck characteristic; and
recording the completed transfer in the reporting database module upon successful verification of the security token, and transmitting a security signal upon unsuccessful verification of the security token.

2. The system and method of claim 1 further wherein the token scanning device is embedded in a mechanical shuffling device configured to randomize the card deck.

3. The system and method of claim 1 further comprising the step of shuffling the deck using a mechanical shuffling device comprising an optical scanner capable of reading a security token applied to a card deck.

4. The system and method of claim 1 wherein the security token is one of: a bar code, alphanumeric string, mechanical marking, or RFID device.

5. The system and method of claim 1 wherein the security token is configured to reflect a wavelength of light outside the visible spectrum.

6. The system and method of claim 1 wherein the security token is an alphanumeric string containing information about the card deck including at least one of: card type, card size, and card manufacturer.

7. The system and method of claim 6 wherein the security token is encrypted.

8. The system and method of claim 1 further comprising the step of utilizing a reporting engine to receive data from the database module concerning the movement of card decks and prepare reports on card utilization.

9. A system and method for tracking and verifying playing cards in a playing environment, comprising the steps of:
receiving an unused card deck comprising a plurality of playing cards;
scanning the cards in the card deck to determine whether a security token has been applied to cards in the card deck and, where no security token is identified, generating and assigning a security token to at least one card in the card deck;
recording the security token in a database module;
causing the card deck to be transferred to a game environment in response to a transfer request for a new card deck, and recording the transfer in the reporting database module;
receiving the card deck at the game environment and reading the security token applied to the at least one card in the card deck;
performing a database lookup of the security token present on the at least one card in the card deck to verify at least one card deck characteristic; and
recording the completed transfer upon successful verification of the security token, and transmitting a security signal upon successful verification of the security token.

10. The system and method of claim 9 further wherein the token scanning device is embedded in a mechanical shuffling device configured to randomize the card deck.

11. The system and method of claim 9 further comprising the step of shuffling the deck using a mechanical shuffling device comprising an optical scanner capable of reading a security token applied to individual cards in the card deck.

12. The system and method of claim 9 wherein the security token is one of: a bar code, alphanumeric string, mechanical marking, or RFID device.

13. The system and method of claim 9 wherein the security token is configured to reflect a wavelength of light outside the visible spectrum.

14. The system and method of claim 9 wherein the security token is an alphanumeric string containing information about the card deck including at least one of: card type, card size, and card manufacturer.

15. The system and method of claim 9 further comprising the step of utilizing a reporting engine to receive data concerning the movement of card decks and prepare reports on card utilization.

16. A system for tracking and verifying playing cards in a playing environment, comprising:
means for scanning an unused card deck to determine whether a security token has been applied to the card deck and, where no security token is identified, generating and assigning a security token to the card deck;
a database configured to securely store a plurality of security tokens and performance metrics associated with the objects associated with the security tokens;
means for randomizing the cards in a card deck prior to play;
means for verifying the integrity of a card deck following transfer to a playing environment and before play has commenced;
means for tracking and recording the position of individual playing cards over time and recording that information in the database;
means for generating reports comprising information in the database.
